(19) United States
(12) Patent Application Publication
(10) Pub. No.: US 2005/0121878 A1
(43) Pub. Date: Jun. 9, 2005

(54) Ram-based positioning system

(76) Inventor: Gerald Muldoon, Dungannon (GB)

Correspondence Address: Jay H Maioli;Cooper & Dunham, 1185 Avenue of the Americas, New York, NY, 10036, US

(21) Appl. No.: 10/499,425

(22) PCT Filed: Dec. 19, 2002
(86) PCT No.: PCT/EP02/14872

(30) Foreign Application Priority Data
Dec. 20, 2001 (GB) 0130402.1

(51) Int. Cl. B62D 53/06

(52) U.S. Cl. 280/426

(57) ABSTRACT

One aspect of the invention provides a positioning system comprising at least one master ram and respective slave ram, at least one travel stop and at least one pressure relief valve. The or each travel stop is arranged to restrict the travel of one or more slave piston when the system is misaligned, at least one pressure relief valve being arranged to vent excess pressure in the operating fluid arising as a result of such restriction. The positioning system is particularly suited for incorporation into a steering system, especially for an articulated vehicle.

### FIELD OF THE INVENTION

The present invention relates to a ram-based positioning system. The invention relates particularly, but not exclusively, to a steering system for an articulated vehicle.

### BACKGROUND TO THE INVENTION

It is known for the steering system of an articulated vehicle to comprise a ram-based positioning system. Typically, the steering system comprises one or more pairs of master/slave hydraulic rams wherein the slave rams are arranged to steer the rear axle of the vehicle. A problem which such systems is that they can often become misaligned as a result of, for example, loss of hydraulic liquid through leakage or through a pressure relief valve during an emergency operation.

In a conventional system, alignment has to be restored manually, typically by centralising the steering axle and king pin sensor to a reference point, then opening and closing the system valves in sequence and manually re-priming the system. This is a relatively time consuming and awkward procedure, not least because the driver needs to leave the vehicle unless he has assistance.

It would be desirable, therefore, to provide a ram-based positioning system which may readily be re-aligned by, for example, the driver of an articulated vehicle, without the need for assistance or the need to leave the vehicle.

### SUMMARY OF THE INVENTION

Accordingly, a first aspect of the invention provides a positioning system comprising at least one master ram and respective slave ram, each ram being fluid operable and having a respective piston and a respective piston chamber, the or each master ram and respective slave ram being arranged, when in a state of normal alignment, so that actuation of the master piston with respect to the master piston chamber causes a corresponding actuation of the slave piston with respect to the slave piston chamber, wherein the system further includes at least one travel stop and at least one pressure relief valve, the or each travel stop being arranged to restrict the travel of one or more slave piston when the system is misaligned, at least one pressure relief valve being arranged to vent excess pressure in the operating fluid arising as a result of such restriction.

By venting the excess fluid pressure in this way, the system is brought back into normal alignment.

Preferably, in the state of normal alignment, the or each master and respective slave pistons are actuatable between a respective fully extended state and a respective fully retracted state, wherein the or each travel stop is arranged to prevent one or more slave piston from reaching at least one of said fully extended or fully retracted states when the system is misaligned. Once the slave piston is prevented from moving further, excess fluid pressure arises as the master piston continues to move to its fully extended or fully retracted state.

Preferably, each ram comprises a first port and a second port for the inlet and outlet of operating fluid, wherein the ports of the master ram are connected to the ports of the slave ram with a one-to-one correspondence, and wherein a respective pressure relief valve is connected to at least one pair of connected ports. More preferably, a respective pressure relief valve is connected to each pair of connected ports.

Preferably, the, or each, pressure relief valve is arranged to direct vented operating fluid to an accumulator.

A second aspect of the invention provides a steering system comprising the positioning system of the first aspect of the invention.

Preferably, the or each master ram is mountable on a vehicle such that, upon turning of the vehicle, the or each master piston is actuated, and wherein the or each respective slave piston is adapted for steering at least one wheel of the vehicle. More preferably, said at least one wheel is carried by a steerable axle, the or each respective slave piston being adapted to steer said steerable axle.

Preferably, the steering system is arranged for steering an articulated vehicle having a tractor unit pivotably coupled to a trailer unit, wherein the or each master piston is actuated upon relative pivoting movement between the tractor unit and the trailer. More preferably, the arrangement is such that, upon extension or retraction of the or each master piston, the respective slave piston is retracted or extended respectively by a corresponding amount.

Preferably, the steering system comprises a first master ram and a second master ram, each associated with a respective slave ram, the respective slave pistons being coupled to a steerable axle of the vehicle at locations on opposite sides of the pivoting axis of the steerable axle, the arrangement being such that, upon turning of the vehicle, one of the first and second master pistons is caused to retract, the other being caused to extend, the corresponding actuation of the respective slave pistons causing the steerable axle to pivot about its pivoting axis.

Preferably, the or each travel stop is provided on the chassis of a vehicle on which, in use, the steering system in mounted and arranged to restrict the pivoting movement of the steerable axle. Alternatively, the, or each, travel stop is provided on a respective slave ram.

A third aspect of the invention provides a vehicle comprising the steering system of the first aspect of the invention. The invention is particularly suited for use with articulated vehicles.

Preferably, the rams are hydraulically operable, the preferred hydraulic operating liquid being oil.

Other advantageous aspects of the invention will be apparent to those ordinarily skilled in the art upon review of the following description of a specific embodiment of the invention and with reference to the accompanying drawings.

### BRIEF DESCRIPTION OF THE DRAWINGS

A specific embodiment of the invention is now described by way of example and with reference to the accompanying drawings in which like numerals are used to indicate like parts and in which:

FIG. 1 is a plan view of an articulated vehicle including a preferred ram-based steering system embodying one aspect of the invention;

FIG. 2 is a schematic view of a preferred ram-based positioning system embodying another aspect of the invention, and being suitable for use in the steering system in FIG. 1;

FIG. 3 is a schematic view of a hydraulic circuit for use with the positioning system of FIG. 2;

FIG. 4 is a plan view of the articulated vehicle of FIG. 1, wherein the steering system is in a partially locked state and the rear axle is properly aligned;

FIG. 5 is a plan view of the articulated vehicle wherein the steering system is in a fully locked state and the rear axle is properly aligned;

FIG. 6 is a plan view of the articulated wherein the steering mechanism is in a straight ahead state and the rear axle is misaligned;

FIG. 7 is a plan view of the articulated vehicle wherein the steering system is in partially locked state and the rear axle is misaligned.

### DETAILED DESCRIPTION OF THE DRAWINGS

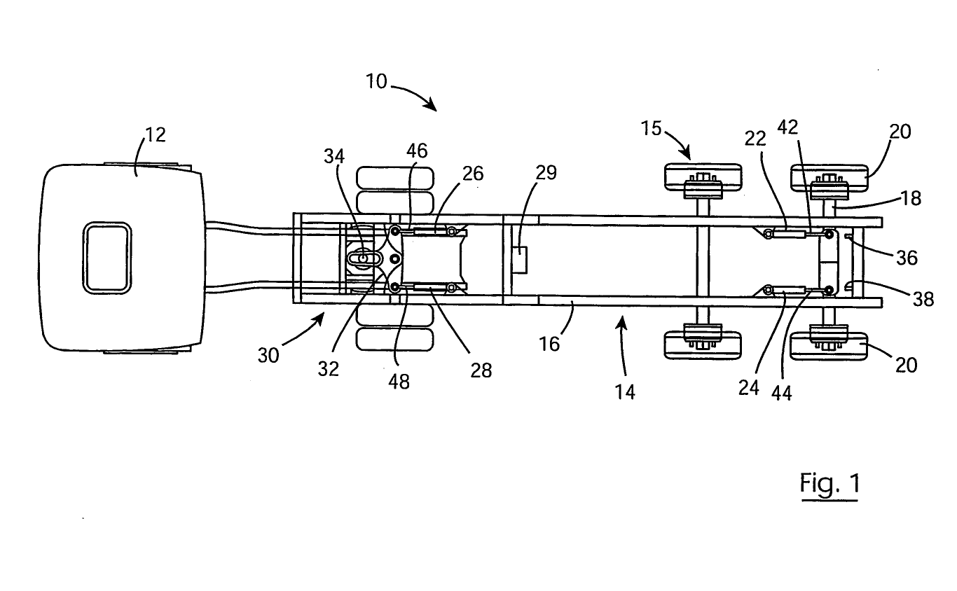

Referring now to FIG. 1 of the drawings there is shown, generally indicated at 10, an articulated vehicle comprising a tractor unit, or tractor, 12 and a trailer 14. The trailer 14 comprises a chassis 16 on which there is pivotably mounted a steerable rear axle 18 carrying a set of wheels 20. Depending on the size of the trailer 14 it may include one or more further axles and wheel sets. In the illustrated embodiment, the trailer 14 includes a further fixed axle/wheel set 15. The vehicle 10 comprises a steering system which includes a positioning system embodying the invention. In the preferred embodiment, the positioning system comprises a first and a second slave ram 22, 24 and a first and second master ram 26, 28, connected to a hydraulic circuit (not shown in FIG. 1) which includes a valve circuit, or valve block 29. Each ram 22, 24, 26, 28 preferably comprises a double acting ram and comprises a respective piston and piston chamber in normal manner.

The rear axle 18 is pivotable with respect to the chassis 16 by the first and second slave rams 22, 24, which have their respective piston chambers mounted on the chassis 16 and their respective. pistons coupled to the rear axle 18. The first and second master rams 26, 28 are also mounted on the chassis 16. The master rams 26, 28 are coupled to a respective slave ram 22, 24 so that operation of a master ram 26, 28 causes a corresponding operation of the respective slave ram 22, 24.

The trailer 14 is pivotably coupled to the tractor 12 by conventional coupling, or linkage mechanism which, in the preferred embodiment, comprises a kingpin mechanism 30 (commonly referred to as a kingpin steering mechanism). The linkage mechanism 30 also forms part of the steering system of the vehicle 10 in that it transmits angular or pivotal movement of the tractor 12 with respect to the trailer 14 to the master rams 26, 28. To this end, the kingpin mechanism 30 includes a crank 32 for converting rotary movement, imparted to the crank 32 during use by the kingpin mechanism 30, into reciprocal movement of the pistons of the master rams 26, 28. In the preferred embodiment, the crank 32 is substantially “T-shaped” (sometimes referred to as a bell crank, or unitary bell crank) and has one end coupled to the kingpin 34, the other two ends being connected to a respective piston of the master rams 26, 28.

The steering system also includes a respective stop member, or travel stop 36, 38, associated with each slave ram 22, 24. The travel stops 36, 38, are arranged for engagement with the steerable rear axle 18 and/or the pistons of the slave rams 22, 24 in certain dispositions of the axle 18/rams 22, 24 as is described in more detail below. In FIG. 1 the travel stops 36, 38 are mounted on the chassis 16 but need not necessarily be so—for example, the travel stops 36, 38 may alternatively be incorporated into the slave rams 22, 24 themselves.

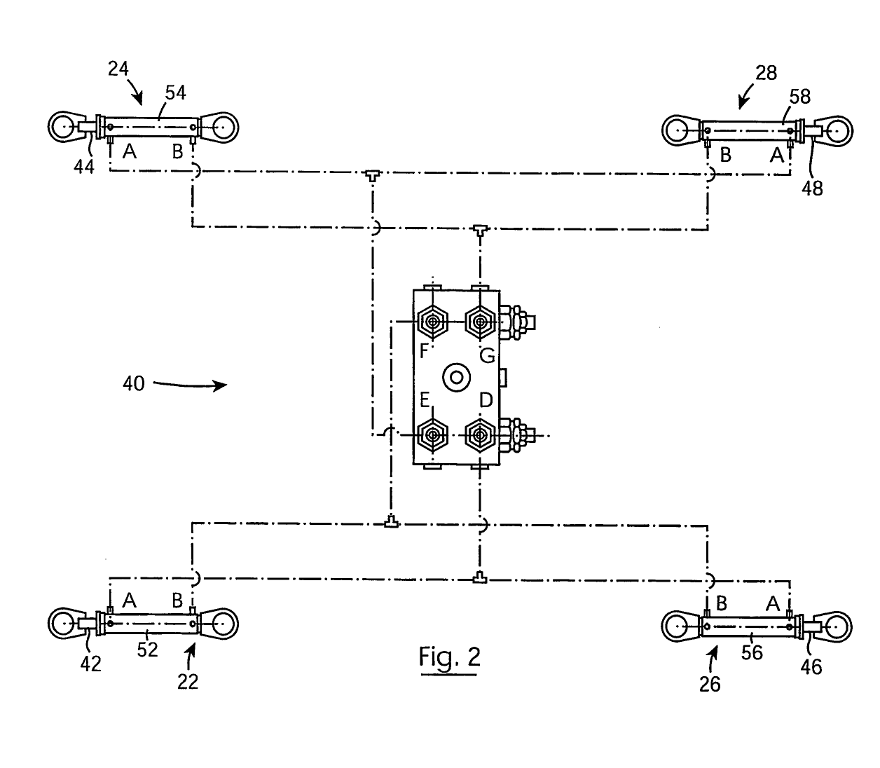

Referring now to FIG. 2, there is shown, generally indicated at 40, the preferred embodiment of the ram-based positioning system. In the preferred embodiment, each ram 22, 24, 26, 28 comprises a hydraulic ram comprising a respective piston 42, 44, 46, 48 and respective piston chamber in the form of cylinders 52, 54, 56, 58. Each cylinder 52, 54, 56, 58 includes two respective ports A, B, for the input and output of hydraulic operating liquid, typically oil. The arrangement is such that inflow of hydraulic liquid via port A causes the respective pistons 42, 44, 46, 48 to retract and an outflow of hydraulic liquid from the respective port B, while inflow of hydraulic liquid via port B causes the respective pistons 42, 44, 46, 48 to extend and an outflow of hydraulic liquid from the respective port A. Equally, a retraction of the respective pistons 42, 44, 46, 48 causes an outflow from the respective port B, while an extension of the pistons 42, 44, 46, 48 causes an outflow from the respective port A.

The master rams 26, 28 are hydraulically connected to the respective slave rams 22, 24 such that the respective port As and port Bs are connected together in a one-to-one correspondence. Thus, when the piston 46, 48 of a master ram 26, 28 extends, the piston 42, 44 of the respective slave ram 22, 24 retracts. Similarly, when the piston 46, 48 of a master ram 26, 28 retracts, the piston 42, 44 of the respective slave ram 22, 24 extends.

Before use, the system 40 is primed with hydraulic fluid in conventional manner such that the relative states (in terms of piston extension/retraction) of the rams 22, 24, 26, 28 are properly aligned (normal alignment) for the intended use. Thus, for a given extension/retraction of the master ram 26, 28, there is an appropriate corresponding retraction/extension of the respective slave ram 22, 24. It is noted that in FIG. 2, all of the rams 22, 24, 26, 28 are shown in a retracted state, which is not a normal operating mode of the system 40 when used to implement the steering system described above. It will also be noted that, although the present embodiment requires that the respective port As of the rams are connected together, as are the respective port Bs, this need not necessarily be the case. For example, in alternative applications, the arrangement may be such that an extension in one (or both) of the master pistons 46, 48 causes an extension in the respective slave piston 42, 44.

The system 40 may become misaligned, i.e. removed from the normal alignment state, for a variety of reasons including loss of hydraulic liquid through leakage that commonly occurs over a period of time through, for example, cylinder seals (not shown) and valve assemblies (not shown). Hydraulic liquid may also be lost during emergency operations in which hydraulic liquid is shed through relief valves. When misaligned, the relative states of the rams 22, 24, 26, 28 no longer conform to the required relative arrangement and, as a result, the positioning system 40 does not operate properly.

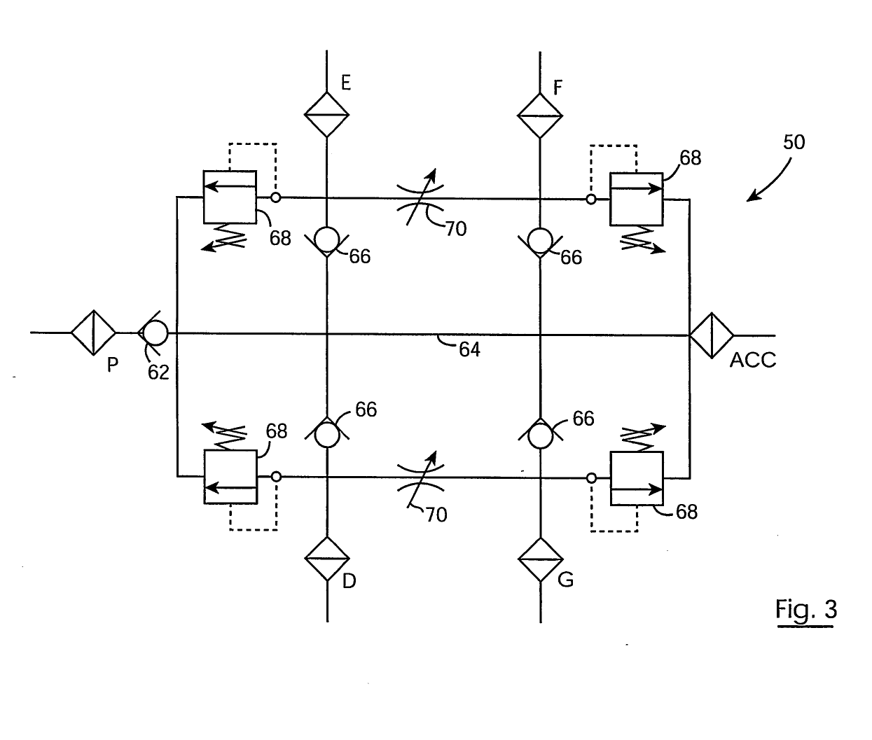

The valve block 29 containing a hydraulic valve circuit (described below with reference to FIG. 3) comprises four main hydraulic ports D, E, F, G for the input and output of hydraulic liquid. The rams 22, 24, 26, 28 are connected to the valve block 29 by hydraulic lines (shown dashed in FIG. 2) such that port D of the valve block 29 is hydraulically connected to the respective port A of rams 22, 26; port E is hydraulically connected to the respective port A of rams 24, 28; port F is hydraulically connected to the respective port B of rams 22, 26; and port G is hydraulically connected to the respective port B of rams 24, 28. The hydraulic circuit within the valve block 29 implements a pressure relief system that enables the positioning system 40 to be readily re-aligned, as is described below.

Referring now to FIG. 3, there is shown the hydraulic circuit, generally indicated at 50, implemented by valve block 29. In addition to ports D, E, F and G, the circuit 50 includes a priming port P which is connectable to a conventional priming pump (not shown) in conventional manner. A one-way valve, or check valve 62, is associated with the priming port P to prevent hydraulic liquid from leaving the circuit 50 by this port P. The circuit 50 further includes an accumulator port ACC which is connectable to a conventional hydraulic accumulator (not shown) in conventional manner. The priming pump and hydraulic accumulator are used to charge, or prime, the valve circuitry 50 and associated hydraulic circuit in conventional manner.

The circuit 50 comprises a main hydraulic feed line 64 which is in hydraulic communication with each of ports D, E, F and G via a respective one-way valve 66, each valve 66 being arranged to allow hydraulic liquid to flow from the main feed line 64 and out through the respective port D, E, F, G, but not in the reverse direction.

Each port D, E, F, G is also in hydraulic communication with a respective conventional pressure relief valve 68 which, in the preferred embodiment, are adjustable (or variable) pressure relief valves. Each pressure relief valve 68 is located between the respective port D, E, F, G and the main feed line 64 and is arranged to allow hydraulic liquid to flow from the respective port D, E, F, G to the main feed line 64 only when the pressure of the hydraulic liquid exceeds a threshold value, the threshold value being determined by the setting of the respective variable pressure relief valve 68. The pressure relief valves 68 do not allow hydraulic liquid to flow in the reverse direction.

Circuit 50 further includes two conventional flow control valves 70 which connect, when open, ports D and G and ports F and E, respectively. In normal operation of the circuit 50, the valves 70 remain closed and are effectively open-circuit (i.e. isolating port D from port G and port E from port F). During the initial setting up of the position system 40, however, the flow control valves 70 are opened to facilitate initial alignment of the positioning system 40. In the context of the steering system outlined in FIG. 1, this means that the hydraulic liquid is able to flow directly between the rams on either side of the trailer 14. This allows the pistons 42, 44 of the slave rams 22, 24 to move independently of the pistons 46, 48 of the master rams 26, 28 so that the steering system can be properly aligned during the setting up of the hydraulic circuitry.

The operation of the positioning system 40 is now described in the context of a vehicle steering system. FIG. 1 shows the articulated vehicle 10 in a straight ahead state in which the tractor 12 and the trailer 14 are substantially in register with one another i.e. the respective longitudinal axis of the tractor 12 and trailer 14 are substantially coincident. In this state, when the positioning system 40 is in normal alignment (as shown in FIG. 1), the slave rams 22, 24 hold the rear axle 18 substantially perpendicularly with respect to the longitudinal axis of the tractor 12/trailer 14. Thus, the wheels 20 are substantially parallel with the trailer 14 i.e. ready for straight ahead movement of the vehicle 10. Assuming that the slave rams 22, 24 are positioned substantially ih register with one another on the chassis 16 (as shown in FIG. 1), the slave pistons 42, 44 are extended by substantially equal amounts with respect to their cylinder 52, 54. Similarly, assuming that the crank 32 is symmetrically located on the chassis 16 and that the master rams 26, 28 are substantially in register (as shown in FIG. 1), then the master pistons 46, 48 are extended by substantially equal amounts with respect to their cylinder 56, 58. FIG. 1 therefore shows the positioning system in normal alignment.

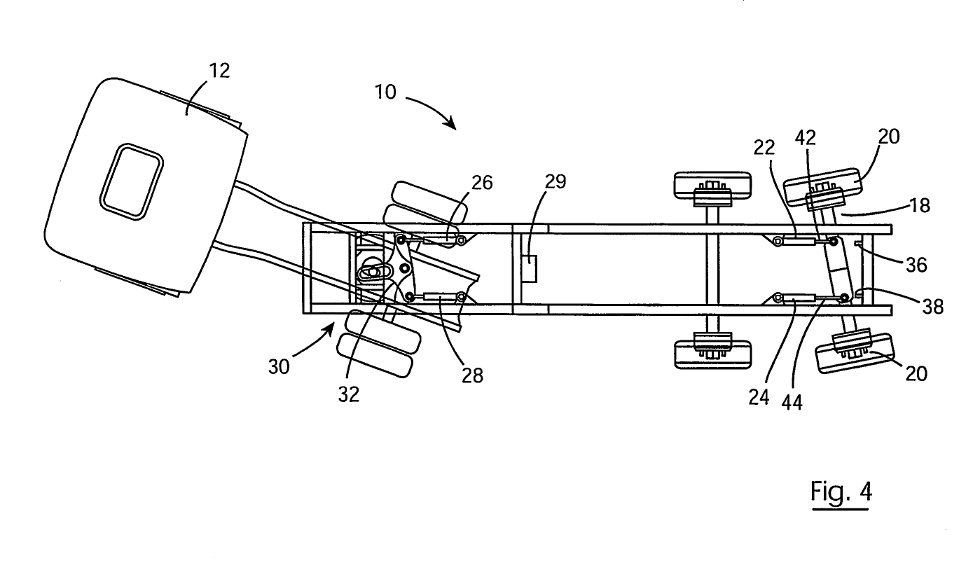

In FIG. 4, the steering system of the vehicle 10 is in a partially locked state (i.e. not at full turn) such that the tractor 12 is angularly disposed with respect to the trailer 14 (i.e. the respective longitudinal axis of the tractor 12 and trailer 14 are not coincident). The angular displacement of the tractor 12 with respect to the trailer 14 is translated into a corresponding angular displacement of the crank 32 with respect to its FIG. 1 “straight ahead” position. As the crank 32 rotates (anti-clockwise as viewed in FIG. 4) it causes the piston 46 of master ram 26 to extend and the piston 48 of master ram 28 to retract. This causes corresponding retraction of the slave piston 42 and extension of the slave piston 44. As a result, the rear axle 18 is pivoted anti-clockwise (as viewed in FIG. 4). Thus, the wheels 20, which are now angularly disposed with respect to the chassis 16, are in a position to facilitate the vehicle 10 making a clockwise turn (as viewed in FIG. 4). FIG. 4 also shows the positioning system in normal alignment.

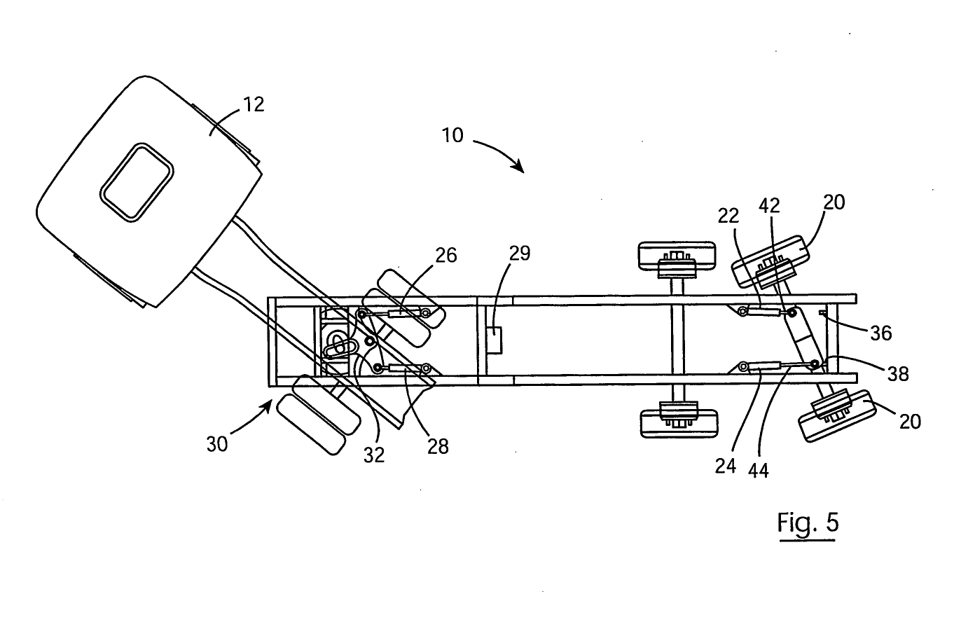

FIG. 5 shows the vehicle 10 with its steering system in a fully locked state and still in normal alignment. The situation is similar to that of FIG. 4 except the crank 32 is now in its maximum angular disposition with respect to the chassis 16 (for a clockwise turn in normal use). Consequently, the master pistons 46, 48 are in extended and retracted states respectively corresponding to this fully locked state, and the slave pistons 42, 44 are in their corresponding retracted and extended states respectively (these piston states may be regarded as the fully extended or fully retracted states of the pistons since they define the limit of the pistons travel during normal use, although these states may not correspond to the physical limits of extension/retraction of which the respective pistons are capable). The travel stop 38 is arranged, or positioned, so that in this fully locked state, the rear axle 18 just comes into contact with, or falls just short of, the travel stop 38. It may be said that the rear axle 18 substantially abuts with the travel stop 38 such that travel of the slave piston 44 is substantially unrestricted by the travel stop 38. It will be appreciated that the travel stop 38 may alternatively be arranged to lie in the path of the piston 44 itself such that the piston substantially abuts with the travel stop 38 in the fully locked state.

The other travel stop 36 is similarly arranged with respect to the other slave piston 42. Thus, when the steering system of the vehicle 10 is in the opposite fully locked state (for an anti-clockwise turn as viewed in FIG. 5—not illustrated), the rear axle 18 (or alternatively the slave piston 42) substantially abuts with the travel stop 36 such that travel of the slave piston 42 is substantially unrestricted by the travel stop 36.

The forgoing descriptions referring to FIGS. 1, 4 and 5 relate to normal operation of the steering system, and therefore of the positioning system 40, in normal alignment. In such conditions, the valve circuit 50 is inactive. Hydraulic liquid is prevented from entering the circuit 50 via ports D, E, F and G because the hydraulic pressure is not great enough to allow the liquid to pass through the pressure relief valves 68.

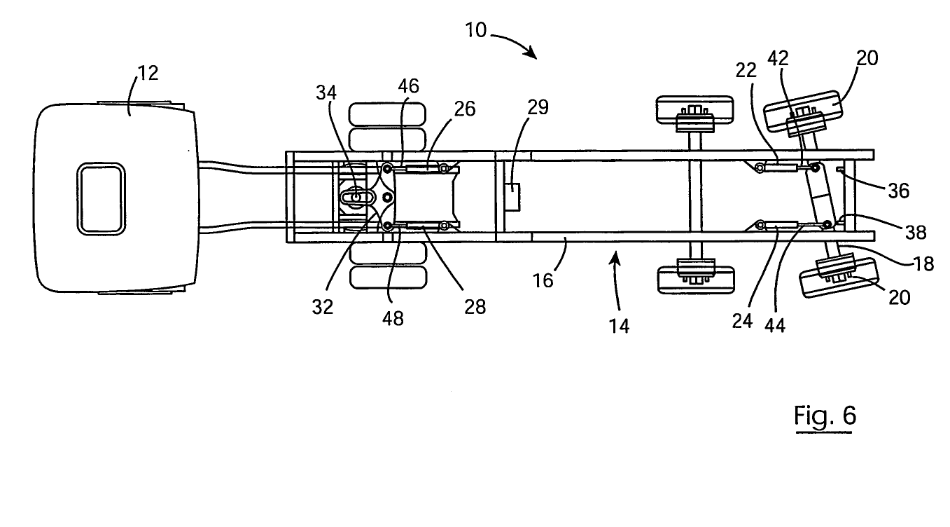

FIG. 6 shows the vehicle 10 in the straight ahead state but with the positioning system 40 misaligned. The relative extension/retraction of the slave pistons 42, 44 do not correspond correctly with the respective master piston 46, 48 extension/retraction in this state. As a result, the wheels 20 are angularly disposed with respect to the chassis 16 when they should be substantially parallel with it. Clearly, the orientation of the wheels 20 is unsuitable for straight ahead travel of the vehicle 10 and requires re-alignment. Re-alignment is readily achieved using the positioning system 40, and in particular the valve block 29, as is now described.

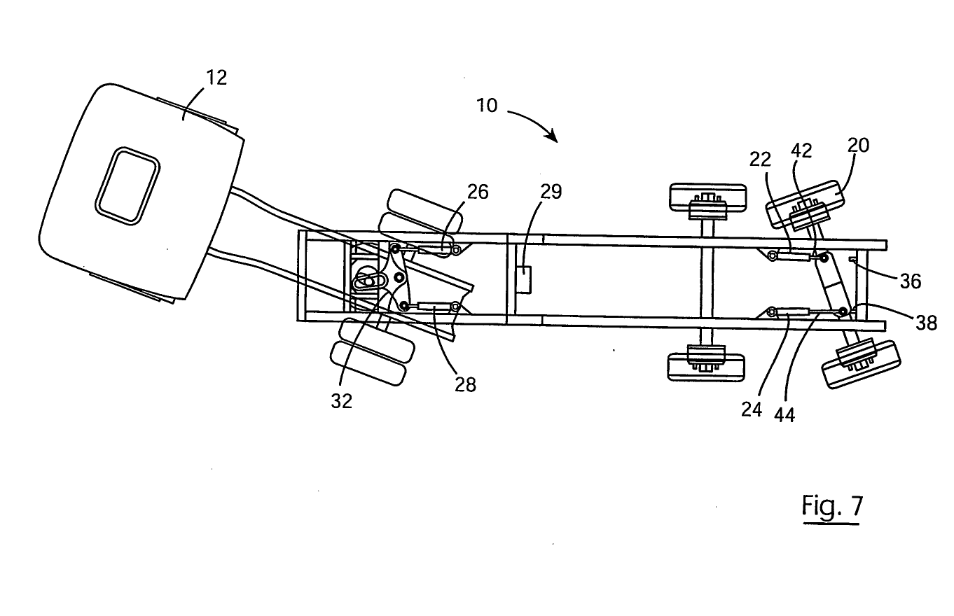

Starting from the position illustrated in FIG. 6, as the vehicle 10 makes a clockwise turn, the slave piston 44 extends and the other slave piston 42 retracts. However, because the slave piston 44 was already further extended than it should have been before the vehicle 10 started to turn (i.e. out of alignment), the rear axle 18 abuts with the travel stop 38 before the steering system of the vehicle 10 has reached the fully locked state (illustrated in FIG. 7). The travel stop 38 thus prevents the slave piston 44 from reaching the extended state that corresponds to the fully locked state shown in FIG. 5. However, as the steering system continues towards the fully locked state, the master piston 48 continues to retract as normal. Because the slave piston 44 is prevented by the travel stop 38 from extending further, this results in a build up of hydraulic pressure since master piston 48 is forcing hydraulic liquid out of port B of master ram 28 but port B of slave ram 24 is unable to receive this hydraulic liquid. The build up of hydraulic pressure causes hydraulic liquid to enter the valve block 29 via port G and flow through the associated pressure relief valve 68. The pressure relief valve 68 is suitably adjusted to allow hydraulic liquid to pass through it at the pressure levels arising in the situation described above. The hydraulic liquid entering circuit 50 via port G is collected in the accumulator.

When the steering system, and therefore the positioning system 40, has reached the fully locked state, the rear axle 18 still abuts against the travel stop 38 but the excess hydraulic pressure has now been dissipated through the pressure relief valve 68 associated with port G. Thus, when the steering system is taken out of the fully locked state (in this case by an anti-clockwise turn of the vehicle 10) the slave piston 44 now retracts correctly as the master piston 48 extends. Moreover, the slave piston 44 will extend correctly the next time the master piston 48 retracts. Hence, the positioning system 40 has been re-aligned to normal alignment.

Similarly, by putting the steering system, and therefore the positioning system 40, into the opposite fully locked position (not illustrated) a misalignment caused by an over-extension of the other slave piston 42 can be corrected. In this case, the slave piston 42 abuts against the other travel stop 36 and the excess hydraulic pressure is vented through port F and the associated pressure relief valve 68.

Thus, it will be appreciated that the positioning system 40 allows a misalignment of a steering system of the type described above to be corrected simply by putting the steering system, and therefore the positioning system 40, into one fully locked state and, if necessary, then the opposite fully locked state.

Ports D and E operate in complement to ports G and F respectively in normal manner when the rams are double acting rams. For example, in the FIG. 2 arrangement, an inflow of oil at port G may be balanced in normal manner by an outflow of oil at port E. In alternative embodiments (not illustrated), the ports D, E, F, G and associated pressure relief valves 68 may operate in alternative configurations. For example, with reference to FIG. 2, if one or more travel stop was arranged to prevent, say, piston 44 of slave ram 24 from retracting beyond a given state, then the build up of excess hydraulic pressure when the positioning system was misaligned would be vented mainly by hydraulic liquid passing through the pressure relief valve 68 associated with port E.

It will be understood that the slave rams 22, 24 need not necessary be arranged to actuate a rear axle—they could be used to operate any steerable axle. Further, in cases where the wheels themselves are steerable, the slave rams may be arranged to actuate the steerable wheels (rather than the axle). Moreover, there need not necessarily be two pairs of master/slave rams—the invention may be applied in positioning systems comprising one or more pairs of master/slave rams. The rams need not necessarily be hydraulic but may alternatively be operatable by any other suitable operating fluid.

The positioning system of the invention is not limited to use in a steering system of an articulated, or any other, vehicle. The invention may be employed in any positioning system comprising at least one pair of master/slave rams in order to correct the relative alignment of the master and slave rams. Depending on the requirements of the application, the, or each, travel stop may be arranged to prevent the, or each, respective slave piston from extending and/or retracting more than is necessary when the system is normally aligned.

The invention is not limited to the embodiments described herein which may be modified or varied without departing from the scope of the invention.

1. A positioning system comprising at least one master ram and respective slave ram, each ram being fluid operable and having a respective piston and a respective piston chamber, the or each master ram and respective slave ram being arranged, when in a state of normal alignment, so that actuation of the master piston with respect to the master piston chamber causes a corresponding actuation of the slave piston with respect to the slave piston chamber, wherein the system further includes at least one travel stop and at least one pressure relief valve, the or each travel stop being arranged to restrict the travel of one or more slave piston when the system is misaligned, at least one pressure relief valve being arranged to vent excess pressure in the operating fluid arising as a result of such restriction.

2. A positioning system as claimed in claim 1, in which, in the state of normal alignment, the or each master and respective slave pistons are actuatable between a respective fully extended state and a respective fully retracted state, wherein the or each travel stop is arranged to prevent one or more slave piston from reaching at least one of said fully extended or fully retracted states when the system is misaligned.

3. A positioning system as claimed in claim 1 or 2, in which each ram comprises a first port and a second port for the inlet and outlet of operating fluid, wherein the ports of the master ram are connected to the ports of the slave ram with a one-to-one correspondence, and wherein a respective pressure relief valve is connected to at least one pair of connected ports.

4. A positioning system as claimed in claim 3, in which a respective pressure relief valve is connected to each pair of connected ports.

5. A positioning system as claimed in any preceding claim, wherein the, or each, pressure relief valve is arranged to direct vented operating fluid to an accumulator.

6. A steering system comprising a positioning system as claimed in claim 1.

7. A steering system as claimed in claim 6, wherein the or each master ram is mountable on a vehicle such that, upon turning of the vehicle, the or each master piston is actuated, and wherein the or each respective slave piston is adapted for steering at least one wheel of the vehicle.

8. A steering system as claimed in claim 7, wherein said at least one wheel is carried by a steerable axle, the or each respective slave piston being adapted to steer said steerable axle.

9. A steering system as claimed in claim 7 or 8, arranged for steering an articulated vehicle having a tractor unit pivotably coupled to a trailer unit, wherein the or each master piston is actuated upon relative pivoting movement between the tractor unit and the trailer.

10. A steering system as claimed in claim 9, wherein the arrangement is such that, upon extension or retraction of the or each master piston, the respective slave piston is retracted or extended respectively by a corresponding amount.

11. A steering system as claimed in any of claims 8 to 10, comprising a first master ram and a second master ram, each associated with a respective slave ram, the respective slave pistons being coupled to a steerable axle of the vehicle at locations on opposite sides of the pivoting axis of the steerable axle, the arrangement being such that, upon turning of the vehicle, one of the first and second master pistons is caused to retract, the other being caused to extend, the corresponding actuation of the respective slave pistons causing the steerable axle to pivot about its pivoting axis.

12. A steering system as claimed in any of claims 9 to 11 when dependent on claim 8, wherein the or each travel stop is provided on the chassis of a vehicle on which, in use, the steering system in mounted and arranged to restrict the pivoting movement of the steerable axle.

13. A vehicle comprising a steering system as claimed in claim 6.
